(19) United States
(12) Patent Application Publication
(10) Pub. No.: US 2010/0052878 A1
(43) Pub. Date: Mar. 4, 2010

(54) VIBRATING APPARATUS OF A PORTABLE ELECTRONIC DEVICE

(75) Inventor: YANG-YU CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/328,860

(22) Filed: Dec. 5, 2008

(30) Foreign Application Priority Data
Aug. 26, 2008 (CN) 200810304202.X

(51) Int. Cl. H04B 3/36

(52) U.S. Cl. 340/407.1

(57) ABSTRACT

A vibrating apparatus installed in a portable electronic device includes a vibrator, a regulator connected to the vibrator, and a controller connected to the regulator. The controller generates controlling signals and sends the controlling signals to the regulator to actuating the vibrator to vibrate and regulates vibrating parameters of the vibrator.

### BACKGROUND

1. Field of the Invention

The present invention relates to a vibrating apparatus of a portable electronic device, and particularly to an adjustable vibrating apparatus of a portable electronic device.

2. Description of Related Art

Nowadays, vibrating apparatuses are widely used in portable electronic devices such as mobile phones and personal digital assistants (PDAs). A portable electronic device can be set into a vibrating mode when silence is needed. When the portable electronic device receives a call or a message, it can silently alert the user by vibration.

In use of a portable electronic device, a user often need distinguish the types of calls and messages received thereby, and then process the important ones in priority. For example, a portable electronic device can usually store many kinds of ringtones, and the user can set various ringtones corresponding to each stored phone number. When the portable electronic device receives a call or a message from a stored number, the user can identify number of the call or message by the played ringtone. Thus, the user can determine if a received call or message need be processed immediately, without looking at the display of the portable electronic device.

However, at the present time, most typical portable electronic devices do not the ability to set various vibrations corresponding to each stored phone number. In use, when a typical portable electronic device is in a vibrating mode, it usually has only one vibrating mode despite it receiving calls or messages from different phone numbers. Thus, the user cannot identify the number of the call or message received by the portable electronic device according to only the vibration thereof, and still need to look at the display of the portable electronic device to see the number.

Therefore, there is room for improvement within the art.

### BRIEF DESCRIPTION OF THE DRAWINGS

Many aspects of the present vibrating apparatus can be better understood with reference to the following drawings. The components in the various drawings are not necessarily drawn to scale, the emphasis instead being placed upon clearly illustrating the principles of the present vibrating apparatus. Moreover, in the drawings, like reference numerals designate corresponding parts throughout the figures.

FIG. 1 is a diagram of a vibrating apparatus, according to an exemplary embodiment.

FIG. 2 is a circuit diagram of the vibrating apparatus shown in FIG. 1.

### DETAILED DESCRIPTION OF THE EXEMPLARY EMBODIMENT

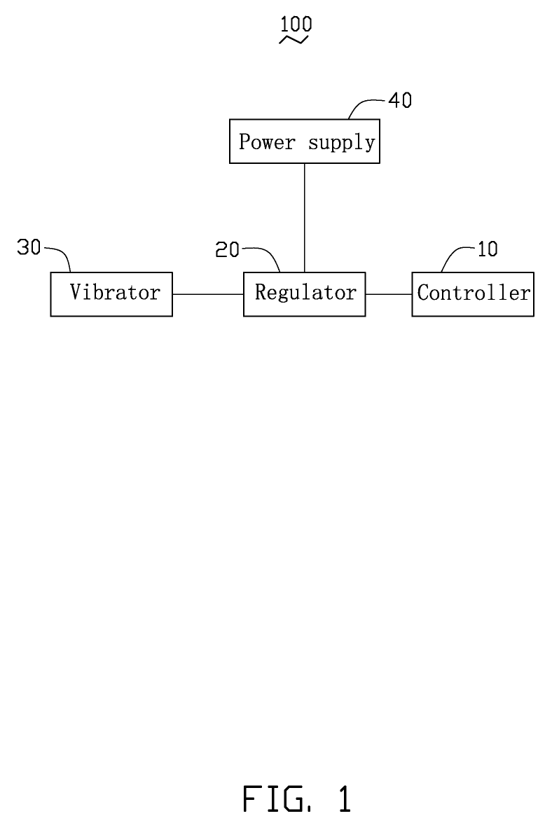

Referring to FIG. 1, a vibrating apparatus 100 according to an exemplary embodiment is provided. The vibrating apparatus 100 is installed in a portable electronic device, such as a mobile phone. When the portable electronic device receives incoming calls, messages or other instructions, the vibrating apparatus 100 vibrates according to the received information to silently alert the user.

The vibrating apparatus 100 includes a controller 10, a regulator 20, a vibrator 30 and a power supply 40. The controller 10 and the power supply 40 are both electronically connected to the vibrator 30 via the regulator 20.

The controller 10 is a microprocessor installed in the portable electronic device and connected to corresponding circuits thereof. The controller 10 can be an independent component added into the portable electronic device, and can also be integrated with conventional circuits of the portable electronic device. The controller 10 can generate controlling signals to actuate the vibrator 30.

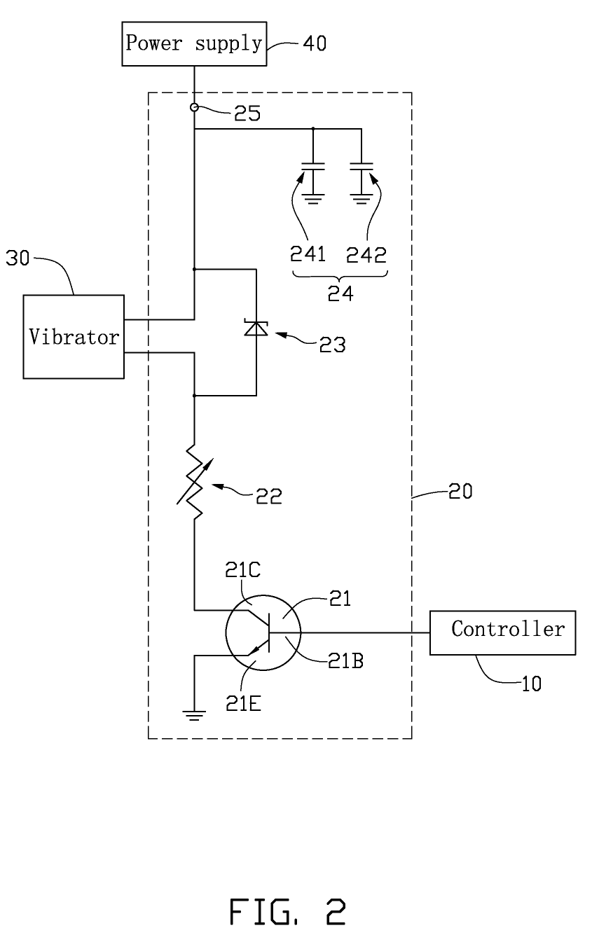

Also referring to FIG. 2, the regulator 20 includes an amplifier 21, a potentiometer 22, a diode 23, a capacitor group 24 and a power connector 25. The amplifier 21, the potentiometer 22, the diode 23 and the capacitor group 24 are electronically connected in series. The power connector 25 is electronically connected to a cathode of the diode 23.

The amplifier 21 is a bipolar junction transistor having a base 21B, a collector 21C and an emitter 21E. The base 21B is connected to the controller 10. The emitter 21E is grounded. The potentiometer 22 is a digital potentiometer capable of changing a resistance thereof according to received controlling signals of the controller 10. The potentiometer 22 has one end connected to the collector 21C and another end connected to an anode of the diode 23. Controlling signals generated by the controller 10 can be inputted into the base 21B, and then are amplified by the amplifier 21 and outputted from the collector 21C to the potentiometer 22. Thus, a resistance of the potentiometer 22 can be controlled by the controller 10.

The capacitor group 24 is used to prevent the controlling signals from interfering with the vibrations of the vibrator 30. The capacitor group 24 includes a first capacitor 241 having a relatively small capacitance (for example, 10 pF) and a second capacitor 242 having a relatively large capacitance (for example, 4.7 μF). The first capacitor 241 and the second capacitor 242 are connected in parallel between the cathode of the diode 23 and the ground.

The vibrator 30 can be a typical electric vibrator, such as an eccentric motor. The vibrator 30 has one end connected to the power connector 25 and another end connected to the potentiometer 22, i.e., the vibrator 30 and the diode 23 are connected in parallel between the power connector 25 and the potentiometer 22.

The power supply 40 is a direct current (DC) power supply, which can be a battery of the portable electronic device. The power supply 40 is connected to the power connector 25 to supply working electric power to the vibrator 30. Because the power supply 40 is a DC power supply, the capacitor group 24 acts like an open circuit to the power supply 40.

When the vibrating apparatus 100 is turned off, the controller 10 does not generate any controlling signal. Accordingly, the base 21B of the amplifier 21 receives no controlling signal. Thus, the amplifier 21 is kept in an off status, and an open circuit is formed between the collector 21C and the emitter 21E. Despite one end of the vibrator 30 is connected to the power supply 40, no current passes through the vibrator 30 since another end thereof is in an open circuit state. Therefore, the vibrator 30 does not vibrate.

When the portable electronic device receives information such as a call or a message, the vibrating apparatus 100 is turned on. The controller 10 generates a predetermined electronic pulse as controlling signals and inputs the controlling signals to the base 21B of the amplifier 21. The amplifier 21 is then actuated, and the collector 21C is electronically connected to the emitter 21E. Thus, the power supply 40, the vibrator 30 and the potentiometer 20, the collector 21C and the grounded emitter 21E are connected in order to form a circuit. A working current is generated and passes through the vibrator 30 to drive the vibrator 30 to vibrate. Understandably, the controller 10 can directly regulate a vibrating time of the vibrator 30 by generating or stopping the controlling signals.

Additionally, the controlling signals inputted from the base 21B of the amplifier 21 are amplified and sent to the potentiometer 22 from the collector 21C. The amplified controlling signals can regulate the resistance of the potentiometer 22. With regulation of the resistance of the potentiometer 22, a working electric potential of the vibrator 30 and the working current passing through the vibrator 30 can be regulated, and some vibrating parameters, such as swings and frequencies, can also be regulated. The controlling signals passing through the potentiometer 22 reach the anode of the diode 23, and then pass through the diode 23 and reach the capacitor group 24. The first capacitor 241 filters the high-frequency part of the controlling signals and the second capacitor 242 filters the low-frequency part of the controlling signals to prevent the controlling signals interfering the working potential of the vibrator 30. The diode 23 allows the controlling signals flowing from its anode to its cathode to pass through and prevents the working current flowing from its cathode to its anode passing through, such that the vibrator 30 is protected from a short circuit.

In use of the vibrating apparatus 100, a user can set various vibrating modes corresponding to each phone number stored in the controller 10 via typical inputting components, such as a keypad of the portable electronic device. Each vibrating mode has a special combination of some predetermined vibrating parameters, such as vibrating time, swing and frequency etc. When the portable electronic device receives information such as a call or a message, the controller 10 generates a controlling signal according to a predetermined vibrating mode corresponding to the number of the call or the message, thus the vibrator 30 is driven to vibrate. As above-mentioned, some vibrating parameters such as vibrating time (i.e., the lasting time of the controlling signal) can be directly regulated by the controller 10, and some other vibrating parameters such as swing and frequency can be regulated via the potentiometer 22 receiving the controlling signal. In this way, the vibrating parameters of the vibrator 30 are regulated according to the predetermined vibrating mode, and the user can know the number according to the vibration.

In the exemplary vibrating apparatus 100, the controlling signals generated by the controller 10 controls actuating the vibrator 30 to vibrate and regulating vibrating parameters of the vibrator 30 such as vibrating time, swing and frequency. Therefore, the vibrating apparatus 100 has a simplified structure and a low manufacturing cost.

Further, the vibrating parameters such as vibrating time, swing and frequency of the vibrating apparatus 100 can all be predetermined and/or regulated according to demand of the user to form various vibrating modes. When the vibrating apparatus 100 is installed in a portable electronic device, it can vibrate in different predetermined modes corresponding to each phone number stored in the portable electronic device. Thus, when the portable electronic device receives a call or a message from a stored phone number, the user can identify the number according to only the vibration corresponding thereto, and need not looking the display of the portable electronic device.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A vibrating apparatus installed in a portable electronic device, comprising:
a vibrator;
a regulator connected to the vibrator; and
a controller connected to the regulator, wherein the controller generates controlling signals and sends the controlling signals to the regulator for actuating the vibrator to vibrate and regulating vibrating parameters of the vibrator.

2. The vibrating apparatus as claimed in claim 1, wherein the vibrator is an eccentric motor.

3. The vibrating apparatus as claimed in claim 1, wherein the controller is a microprocessor.

4. The vibrating apparatus as claimed in claim 1, wherein the regulator includes a amplifier, the amplifier being a transistor having a base, a collector and an emitter, the base being connected to the controller, and the emitter being grounded.

5. The vibrating apparatus as claimed in claim 4, wherein the regulator includes a potentiometer connected to the collector of the amplifier.

6. The vibrating apparatus as claimed in claim 5, wherein the regulator includes a diode, the potentiometer being connected between the collector of the amplifier and an anode of the diode.

7. The vibrating apparatus as claimed in claim 6, wherein the regulator includes a capacitor group connected between a cathode of the diode and the ground to filter the controlling signals of the controller.

8. The vibrating apparatus as claimed in claim 7, wherein the capacitor group includes a first capacitor having a substantially small capacitance and a second capacitor having a substantially large capacitance relative to the substantially small capacitance, the first capacitor and the second capacitor being connected in parallel between the cathode of the diode and the ground.

9. The vibrating apparatus as claimed in claim 8, wherein the first capacitor is 10 pF and the second capacitor is 4.7 μF.

10. The vibrating apparatus as claimed in claim 8, wherein the regulator includes a power connector connected to the cathode of the diode.

11. The vibrating apparatus as claimed in claim 10, wherein the vibrator and the diode are connected in parallel between the power connector and the potentiometer.

12. The vibrating apparatus as claimed in claim 11, further comprising a direct current (DC) power supply connected to the power connector.

13. The vibrating apparatus as claimed in claim 1, wherein the controlling signal is an electronic pulse.

14. The vibrating apparatus as claimed in claim 1, wherein the potentiometer is a digital potentiometer capable of changing a resistance thereof according to received controlling signals of the controller.

15. The vibrating apparatus as claimed in claim 1, wherein the vibrating parameters of the vibrator are at least one of a vibrating time, a swing and a frequency.
